(19) United States
(12) Patent Application Publication
(10) Pub. No.: US 2008/0055630 A1
(43) Pub. Date: Mar. 6, 2008

(54) SYSTEM AND METHOD FOR MONITORING PRINT JOBS

(75) Inventors: GAO-PENG HU, Shenzhen (CN); CHUNG-I LEE, Tu-Cheng (TW); CHIEN-FA YEH, Tu-Cheng (TW); BOR-CHUAN LIN, Tu-Cheng (TW); JIAN HUANG, Shenzhen (CN); DE-JIA LU, Shenzhen (CN)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: HON HAI PRECISION INDUSTRY CO., LTD., Tu-Cheng (TW)

(21) Appl. No.: 11/615,946

(22) Filed: Dec. 23, 2006

(30) Foreign Application Priority Data
Sep. 5, 2006 (CN) 200610200842.7

(51) Int. Cl. G06F 3/12

(52) U.S. Cl. 358/1.15

(57) ABSTRACT

A method for monitoring print jobs is disclosed. The method includes the steps of: capturing print jobs submitted by client computers; checking the print jobs captured according to predetermined printing tactics that specifies requirements of a valid print job, in order to determine valid print jobs; recording information of all the captured print jobs, and saving the information in the database server; and instructing the printers to execute the valid print jobs. A related system is also disclosed.

### BACKGROUND OF THE INVENTION

1. Field of the Invention

The present invention relates to a system and method for monitoring print jobs.

2. Description of Related Art

A printer is a well-known office machine that can be connected to a computer and outputs printed documents or images. Specifically, the printer receives documents or image data submitted by the computer as print data, translates the print data into a print language which is appropriate for setting printing conditions, and outputs the print data on a piece of paper using a colored dye such as ink or toner. Printers are generally used accompanying with a computer to print various kinds of items such as letters, documents, images, etc. In certain environments, it is necessary and desirable to monitor each print job. Benefits may be realized by providing improved functionality to software used in monitoring print jobs.

Current techniques for monitoring a print job are performed through an independent process. For example, in the Microsoft Windows family of operating systems, a printer monitor program independently monitors the spooling of a print job. Generally, the printer monitor program monitors spooling processes. If the print job is locally spooled, as with a locally connected printer, or directly spooled to a remote printer, the progress of spooling the print data to the printing device (either the local printer or the remote printer) is monitored. If the print job is remotely spooled, as with a print server, the progress of spooling a print job from the print server to the printing device is monitored. However, this technique cannot monitor the process of the print job on the printing device.

People are not fully satisfied with this technique. It is worse especially for printing a file going with many problems (for example: when a size of the file to be printed is beyond the range of the capability of a printer), which cannot be monitored automatically. If the size of the file to be printed is beyond the range of the capability of the printer, the printer even may be in a risk. Furthermore, it is time-consuming for a user to check the printer or to wait for the impossible operation.

What is needed, therefore, is a system and method which can monitor print jobs automatically.

### SUMMARY OF THE INVENTION

One preferred embodiment provides a system for monitoring print jobs. The system includes a print server, a database server, printers and client computers. The print server comprises a capturing module, a checking module, a saving module, and a printing module. The capturing module is configured for capturing print jobs submitted by the client computers. The checking module is configured for checking the print jobs captured according to predetermined printing tactics that specifies requirements of a valid print job, in order to determine valid print jobs. The saving module is configured for recording information of all the captured print jobs, and saving the information in the database server. The printing module is configured for instructing the printers to execute the valid print jobs.

Another preferred embodiment provides a method for monitoring print jobs. The method includes the steps of: (a) capturing print jobs submitted by the client computers; (b) checking the captured print jobs according to printing tactics that specifies requirements of a valid print job, in order to determine valid print jobs; (c) recording information of all the captured print jobs, and saving the information in the database server; (d) instructing the printers to execute the valid print jobs.

Other advantages and novel features of the present invention will become more apparent from the following detailed description of preferred embodiments when taken in conjunction with the accompanying drawings.

### BRIEF DESCRIPTION OF THE DRAWINGS

FIG. 1 is a schematic diagram of hardware configuration and an application environment of a system for monitoring print jobs in accordance with a preferred embodiment;

FIG. 2 is a schematic diagram of main function modules of the print server of FIG. 1;

FIG. 3 is an exemplary schematic illustration of printing tactics.

FIG. 4 is a flow chart of a preferred method for monitoring print jobs by utilizing the system of FIG. 1; and

FIG. 5 is an exemplary schematic illustration of a print job with a watermark.

### DETAILED DESCRIPTION OF THE INVENTION

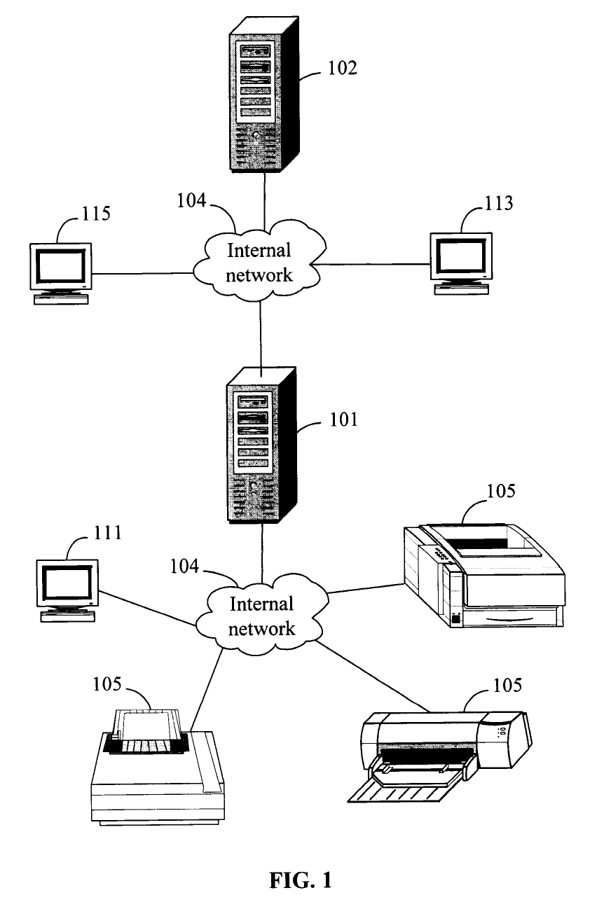

FIG. 1 is a schematic diagram of hardware configuration and an application environment of a system for monitoring print jobs (hereinafter “the system”) in accordance with a preferred embodiment. The system typically is configured in a three-layer framework. The three-layer framework includes a data access layer, a business logic layer, and a presentation layer. The data access layer includes a database server 102. The business logic layer includes a print server 101. The presentation layer includes a plurality of printers 105 and dispersed client computers. For the purpose of conveniently illustrating the preferred embodiment of the present invention, three client computers 111, 113, 115 are shown and described hereinafter. An internal network 104 interconnects all the above-mentioned apparatuses.

The client computers 111, 113, 115 are user interfaces, which are configured for submitting print jobs for users.

The print server 101 stores predetermined printing tactics, and is configured for capturing and checking the print jobs submitted. The printing tactics specifies requirements of a valid print job, in order to determine if the print job submitted is a valid print job or an invalid print job. The print server 101 is also configured for instructing the printers 105 to execute the valid print jobs.

The database server 102 is configured for storing information of all the print jobs.

The printers 105 can be laser printers, ink-jet printers, wire printers, or any other type of printers. The printers 105 are configured for executing the valid print jobs.

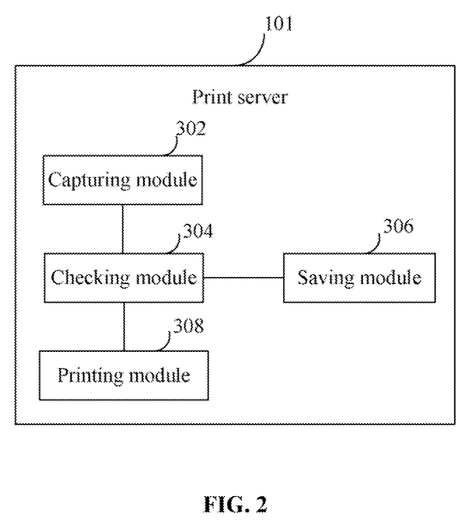

FIG. 2 is a schematic diagram of main function modules of the print server 101. The print server 101 includes a capturing module 302, a checking module 304, a saving module 306, and a printing module 308.

The capturing module 302 is configured for capturing print jobs submitted by the client computers 111, 113, 115.

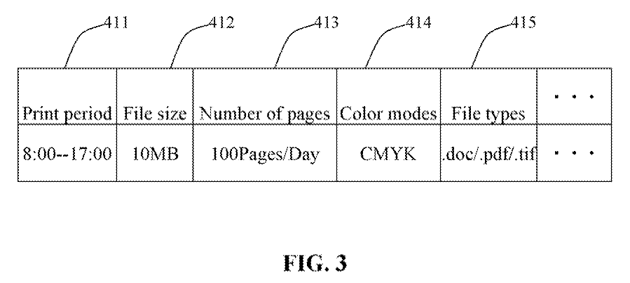

The checking module 304 is configured for checking the captured print jobs. In detail, the checking module 304 checks the captured print jobs according to the printing tactics. The printing tactics mainly includes: a print period, a file size, a number of pages, color modes, and file types (details will be described in relation to FIG. 3). The checking module 304 marks a print job as valid only if the print job satisfies all the printing tactics. Otherwise if the print job does not satisfy all the printing tactics, the checking module 304 marks the print job as invalid. By the checking module 304, valid print jobs and invalid print jobs of the print jobs captured are all marked.

The saving module 306 is configured for recording information of all the captured print jobs, and saving the information in the database server 102. The information of a print job includes: time of the print job when being captured, an owner of the print job, a title of the print job, content of the print job, a file size, a number of pages, color modes, checking result and so on. The checking result is either valid or invalid herein.

The printing module 308 is configured for instructing the printers 105 to execute the valid print jobs

The printing module 308 is further configured for adding watermarks to the valid print jobs executed. In detail, on instructing the printers 105, the printing module 305 adds watermarks to corresponding print jobs, according to the content of the print jobs saved. Actually, the watermarks, used like background, are part of information of the print jobs.

FIG. 3 is an exemplary schematic illustration of the printing tactics. In this embodiment, the printing tactics is expressed in the form of printing tactics table. The printing tactics table mainly includes columns of print period 411, file size 412, number of pages 413, color modes 414, and file types 415. All data in the printing tactics table can be set according to actual needs.

The column for print period 411 specifies a period of time during which printing is allowable. For instance, the data of the print period 411 can be set as 8:00-17:00. If a user submits a print job beyond this period, the print job will not be allowed.

The column for file size 412 specifies allowable size of a print job. For instance, the data of the file size 412 can be set as 10 MB. If a user submits a print job beyond this size, the print job will not be allowed.

The column for number of pages 413 specifies allowable pages of a print job. For instance, the data of the number of pages 413 can be set as 100 pages/day. Users only can print 100 pages in one day.

The column for color modes 414 specifies allowable color modes of a print job. In general, the color modes typically include CMYK and RGB herein.

The column for file types 415 specifies file types of print jobs that are allowable. For instance, the data of the file types 415 can be set as .doc, .pdf, and .tif.

The printing tactics table illustrated is exemplary of the preferred embodiment of the present invention. In alternative embodiments, the printing tactics table may include one or more other columns in lieu of and/or in addition to the above-described columns 411, 412, 413, 414, 415. Such other columns can provide other data on printing tactics. Furthermore, the printing tactics table may be replaced by two or more similar tables.

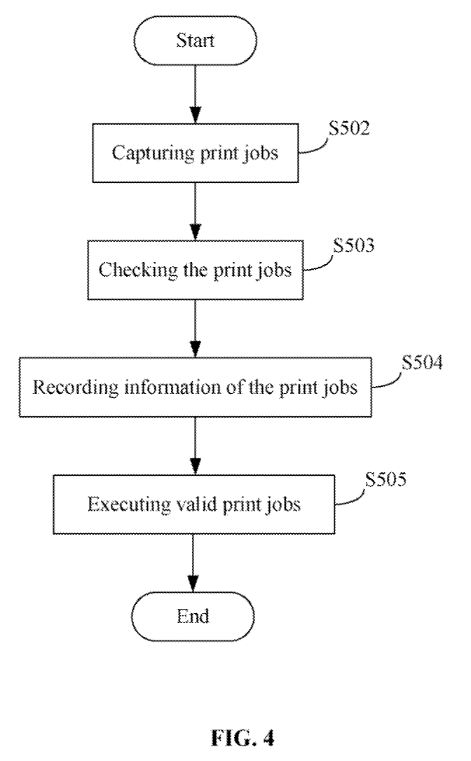

FIG. 4 is a flow chart illustrating a method for monitoring print jobs.

In step S502, the capturing module 302 captures print jobs submitted by the client computers 111, 113, 115.

In step S503, the checking module 304 checks the captured print jobs. In detail, the checking module 304 checks the captured print jobs according to the printing tactics. The printing tactics includes, for example, a print period, a file size, a number of pages, color modes, and file types. The checking module 304 marks a print job as valid, only if the print job satisfies all the printing tactics. Otherwise if the print job does not satisfy all the printing tactics, the checking module 304 marks the print job as invalid. In step S503, valid print jobs and invalid print jobs of the print jobs captured are all marked.

In step S504, the saving module 304 records information of all the captured print jobs, and saves the information in the database server 102. The information of a print job includes: time of the print job when being captured, an owner of the print job, a title of the print job, content of the print job, a file size, a number of pages, color modes, checking result and so on. The checking result is either valid or invalid herein.

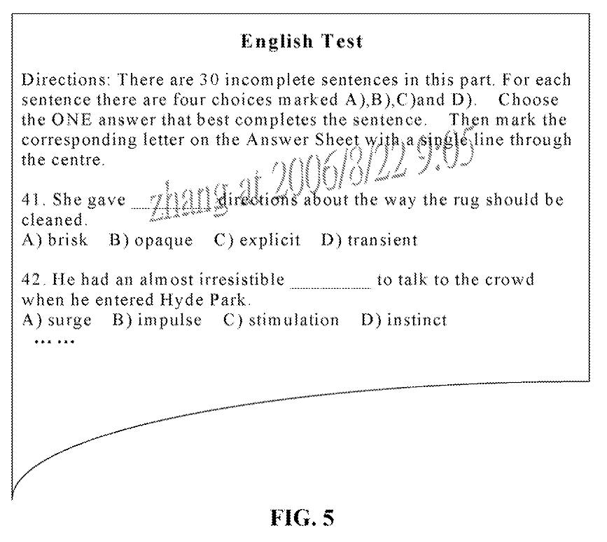

In step S505, the printing module 305 instructs the printers 105 to execute the valid print jobs, and add watermarks to the print jobs at the same time. In detail, on instructing the printers 105, the printing module 305 adds watermarks to corresponding print jobs according to content of the print jobs saved. Actually, the watermarks, which are used like background, are part of information of the print jobs. For instance, the printing module 308 can add time of a print job when being captured and an owner of the print job as watermark (referring to FIG. 5).

Although the present invention has been specifically described on the basis of a preferred embodiment and a preferred method, the invention is not to be construed as being limited thereto. Various changes or modifications may be made to said embodiment and method without departing from the scope and spirit of the invention.

What is claimed is:

1. A system for monitoring print jobs, the system comprising a print server, a database server, printers and client computers, the print server comprising:
a capturing module configured for capturing print jobs submitted by the client computers;
a checking module configured for checking the print jobs captured according to predetermined printing tactics that specifies requirements of a valid print job, in order to determine valid print jobs;
a saving module configured for recording information of all the captured print jobs, and saving the information in the database server; and
a printing module configured for instructing the printers to execute the valid print jobs.

2. The system according to claim 1, wherein the printing module is further configured for adding watermarks to the valid print jobs executed.

3. The system according to claim 1, wherein the printing tactics comprises specification of a print period, a file size, a number of pages, color modes, and file types.

4. The system according to claim 1, wherein the information of a print job comprises at least one item chosen from the group consisting of: time of the print job when being captured, an owner of the print job, a title of the print job, content of the print job, a file size, a number of pages, color modes, and checking result.

5. The system according to claim 3, wherein the checking result is either valid or invalid.

6. A method for monitoring print jobs, the method comprising the steps of:
capturing print jobs submitted by client computers;
checking the print jobs captured according to predetermined printing tactics that specifies requirements of a valid print job, in order to determine valid print jobs;
recording information of all the captured print jobs, and saving the information in the database server; and
instructing the printers to execute the valid print jobs.

7. The method according to claim 6, further comprising the step of:
adding watermarks to the valid print jobs executed.
